(19) United States
(12) Patent Application Publication
(10) Pub. No.: US 2006/0051134 A1
(43) Pub. Date: Mar. 9, 2006

(54) Method of driving device for driving developers and image forming apparatus having the device for driving developers

(75) Inventors: Byung-sun Ahn, Suwon-si (KR); Chung-hwan Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/175,434

(22) Filed: Jul. 7, 2005

(30) Foreign Application Priority Data
Sep. 6, 2004 (KR) 10-2004-0070792

(51) Int. Cl. G03G 15/06

(52) U.S. Cl. 399/222

(57) ABSTRACT

A method of driving a device for driving developers and an image forming apparatus having the device for driving developers are provided. In a two-pass image forming apparatus having two photosensitive media, one or two driving sources are driven by forward and backward rotation to drive two developers disposed around each of the two photosensitive media.

### CROSS-REFERENCE TO RELATED APPLICATIONS

This application claims the benefit of Korean Patent Application No. 10-2004-0070792, filed on Sep. 6, 2004 in the Korean Intellectual Property Office, the disclosure of which is incorporated herein by reference.

### BACKGROUND OF THE INVENTION

1. Field of the Invention

The present invention relates to a two-pass image forming apparatus, and more particularly, to a method of driving a device for driving a plurality of developers using one driving source or two driving sources and an image forming apparatus having the device for driving a plurality of developers.

2. Description of the Related Art

In general, an image forming apparatus, such as a laser beam printer, a light emitting diode (LED) printer, a digital copier, or a facsimile, is a device which forms an electrostatic latent image on a photosensitive drum by scanning light onto the photosensitive medium charged to a uniform electric potential. A developing agent is supplied to the electrostatic latent image using a developer to develop the electrostatic latent image, the developed image is transferred onto an intermediate transfer belt or a paper and fused thereon, thereby forming a single color or multi-color image.

Image forming apparatuses are largely classified into a wet image forming apparatuses and a dry image forming apparatuses based on the developing agent used. The wet image forming apparatus uses a developing agent in which a powdery toner is dispersed in a liquid carrier. The dry image forming apparatus uses a two-component developing agent in which a powdery carrier and a toner are mixed or a one-component developing agent in which the carrier is not contained. The dry image forming apparatus will now be described. For explanatory convenience, a developing agent is referred to as a toner.

In general, toners having four colors such as yellow (Y), cyan (C), magenta (M), and black (K) are needed to print a color image. Thus, four developers that develop toners having four colors are needed. A method of forming a color image includes a single pass method using four laser scanning units (LSUs) and four photosensitive media and a multi-pass method using one exposure unit and one photosensitive medium. In both cases, the four developers described above are generally needed.

In the single pass method, each developer has four driving only sources. In the multi-pass method, driving sources for driving a developer and a photosensitive medium are the same or separated from each other, and a clutch which is a power changing device is disposed in each developer. Thus, the developer having a required color is driven by a clutch in each development pass and bias voltage sources of other developers that do not perform a development operation are disconnected or the developers are isolated from the photosensitive medium. In this way, in the multi-pass method, a power is changed by using the clutch and thus load change occurs. As such, shock or oscillation may affect the developer or the photosensitive medium. Since this shock or oscillation affects the photosensitive medium, this causes image discordance and results in poor image quality. In addition, noise occurs in each clutch operation and may be unpleasant for a user.

### SUMMARY OF THE INVENTION

Additional aspects and/or advantages of the invention will be set forth in part in the description which follows and, in part, will be apparent from the description, or may be learned by practice of the invention.

The present invention provides a device for driving developers that reduces the number of driving sources compared to a conventional device for driving developers using a single pass method, and an image forming apparatus having the device for driving developers.

The present invention also provides a device for driving developers that drives each developer through forward and backward rotation generated by only driving sources, and an image forming apparatus having the device for driving developers.

The present invention also provides a device for driving developers that controls a driving operation of a device for driving developers without a clutch, and an image forming apparatus having the device for driving developers.

According to an aspect of the present invention, there is provided a two-pass image forming apparatus having a first photosensitive medium and a second photosensitive medium, the apparatus including a plurality of developers supplying a developing agent to electrostatic latent images formed on the first photosensitive medium and the second photosensitive medium; a driving source driving the plurality of developers and being rotated forward and backward; and a power transmission unit transmitting a rotating force from the driving source to the plurality of developers, and wherein two of the plurality of developers are disposed around each of the first photosensitive medium and the second photosensitive medium.

The driving source may include a first driving source driving the two developers disposed around the first photosensitive medium; and a second driving source driving the two developers disposed around the second photosensitive medium.

The power transmission unit may include a first power transmission unit to which a rotating force is transmitted from the first driving source; and a second power transmission unit to which a rotating force is transmitted from the second driving source, and wherein one of the two developers disposed to face outer circumferences of the first photosensitive medium and the second photosensitive medium may be selectively driven as the first and second driving sources are rotated forward and backward.

The first and second power transmission units may include a deceleration portion being geared with the first and second driving sources and being rotated, and wherein the deceleration portion may include a deceleration gear.

The first and second power transmission units may include a plurality of one-way power transmission portions transmitting a rotating force in only one direction by a rotating force transmitted from the deceleration gear, and wherein each of the one-way power transmission portions may be disposed to transmit a rotating force in opposite directions.

The one-way power transmission portions may include a first gear driven by the deceleration gear; a second gear being installed on the same shaft as that of the first gear and transmitting a rotating force to a direction of the developer; and a hub clutch being disposed between the first gear and the second gear and transmitting a rotating force to the second gear only when the first gear is rotated in one direction.

The first power transmission unit may include a plurality of gears, the number of gears transmitting a rotating force from the first driving source to one of the two developers may be an even number and the number of gears transmitting a rotating force from the first driving source to the other developer may be an odd number, and wherein the second power transmission unit may include a plurality of gears, the number of gears transmitting a rotating force from the second driving source to one of the two developers may be an even number and the number of gears transmitting a rotating force from the second driving source to the other developer may be an odd number.

The first and second driving sources may be rotated in the same direction.

The first driving source may be rotated forward, the first driving source may drive only one of the two developers disposed around the first photosensitive medium and when the first driving source is rotated backward, the first driving source may drive only the other developer disposed around the first photosensitive medium.

When the second driving source may be rotated forward, the second driving source may drive only one of the two developers disposed around the second photosensitive medium and when the second driving source is rotated backward, the first driving source may drive only the other developer disposed around the second photosensitive medium.

Driving of the first and second driving sources may stop in a non-development section in which a development operation is completed.

When driving of the first and second driving sources stops in the non-development section, a development bias voltage applied to a developing roller disposed in each of the developers may be interrupted.

According to another aspect of the present invention, there is provided a two-pass image forming apparatus having a first photosensitive medium and a second photosensitive medium, the apparatus including a first developer and a second developer each supplying a developing agent to an electrostatic latent image formed on the first photosensitive medium; a third developer and a fourth developer each supplying a developing agent to an electrostatic latent image formed on the second photosensitive medium; one driving source driving the developers and being rotated forward and backward; and a power transmission unit transmitting a rotating force from the driving source to the developers, and wherein, when the driving source is rotated forward, the power transmission unit drives the first and third developers and when the driving source is rotated backward, the power transmission unit drives the second and fourth developers.

The power transmission unit may include first, second, third, and fourth one-way power transmission portions being installed to face the first, second, third, and fourth developers and transmitting a rotating force in only one direction of each of the developers, and wherein, when the driving source is rotated forward, the one-way power transmission portions drive the first and third developers and when the driving source is rotated backward, the one-way power transmission portions drive the second and fourth developers.

The one-way power transmission portions may include a first gear to which a rotating force is transmitted from the driving source; a second gear being installed on the same shaft as that of the first gear and transmitting a rotating force to a direction of the developer; and a hub clutch being disposed between the first gear and the second gear and transmitting a rotating force to the second gear only when the first gear is rotated in one direction.

The power transmission unit may include a plurality of gears, the number of gears transmitting a rotating force from the driving source to the first and third developers may be an even number and the number of gears transmitting a rotating force from the driving source to the second and fourth developers may be an odd number.

According to still another aspect of the present invention, there is provided a method of driving a device for driving developers, the device including a first developer and a second developer each supplying a developing agent to an electrostatic latent image formed on a first photosensitive medium; a third developer and a fourth developer each supplying a developing agent to an electrostatic latent image formed on a second photosensitive medium; one driving source driving the developers and being rotated forward and backward; and a power transmission unit transmitting a rotating force from the driving source to the developers, wherein the method includes rotating the driving source forward; driving the first and third developers as the driving source is rotated forward and supplying the developing agent to the first photosensitive medium and the second photosensitive medium to develop a toner image; rotating the driving source backward; and driving the second and fourth developers as the driving source is rotated backward and supplying the developing agent to the first photosensitive medium and the second photosensitive medium to develop a toner image.

The power transmission unit may include a plurality of one-way power transmission portions transmitting a rotating force in only one direction, and wherein the driving of the first and third developers may include transmitting a rotating force transmitted from the driving source to the one-way power transmission portions; and transmitting a rotating force to only the first and third developers using the one-way power transmission portions to drive the first and third developers.

The power transmission unit may include a plurality of one-way power transmission portions transmitting a rotating force in only one direction, and wherein the backward rotating of the driving source may include transmitting a rotating force transmitted from the driving source to the one-way power transmission portions; and transmitting a rotating force to only the second and fourth developers using the one-way power transmission portions to drive the second and fourth developers.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a two-pass image forming apparatus according to an embodiment of the present invention;

FIG. 2 is a cross-sectional view of a device for driving developers disposed around one photosensitive medium shown in FIG. 1;

FIG. 3 is a cross-sectional view of the device for driving developers disposed around another photosensitive medium shown in FIG. 1;

FIG. 4 is a perspective view of one-way power transmission units shown in FIGS. 2 and 3;

FIG. 5 shows the operation of transmitting power in one direction of the device for driving developers shown in FIG. 2;

FIG. 6 shows the operation of transmitting power in another direction of the device for driving developers shown in FIG. 2;

FIG. 7 shows the operation of transmitting power in one direction of the device for driving developers shown in FIG. 3;

FIG. 8 shows the operation of transmitting power in another direction of the device for driving developers shown in FIG. 3;

FIG. 9 shows the operation of transmitting power in one direction performed by an one-way power transmission power unit;

FIG. 10 shows the operation of transmitting power in another direction performed by an one-way power transmission power unit;

FIG. 11 shows the operation of transmitting power in one direction performed by an one-way power transmission power unit;

FIG. 12 shows the operation of transmitting power in another direction performed by an one-way power transmission power unit;

FIG. 13 is a flowchart illustrating the operation of each of developers when a driving source is rotated forward;

FIG. 14 is a flowchart illustrating the operation of each of developers when a driving source is rotated backward;

FIG. 15 shows the operations of a driving source and developers when the number of drivers for driving a driving source is one;

FIG. 16 shows the operations of a driving source and developers when the number of drivers for driving a driving source is one;

FIG. 17 is a cross-sectional view of the device for driving developers according to another embodiment of the present invention;

FIG. 18 shows the operation of the device for driving developers shown in FIG. 17 when the driving source is rotated forward;

FIG. 19 shows the operation of the device for driving developers shown in FIG. 17 when the driving source is rotated backward;

FIG. 20 is a flowchart illustrating a method of driving the device for driving developers;

FIG. 21 is a flowchart illustrating the method of driving the device for driving developers shown in FIG. 20 when a driving source is rotated forward;

FIG. 22 is a flowchart illustrating the method of driving the device for driving developers shown in FIG. 20 when a driving source is rotated backward;

FIG. 23 is a cross-sectional view of the device for driving developers according to another embodiment of the present invention;

FIG. 24 shows the operation of the device for driving developers shown in FIG. 23 when the driving source is rotated forward; and

FIG. 25 shows the operation of the device for driving developers shown in FIG. 23 when the driving source is rotated backward.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

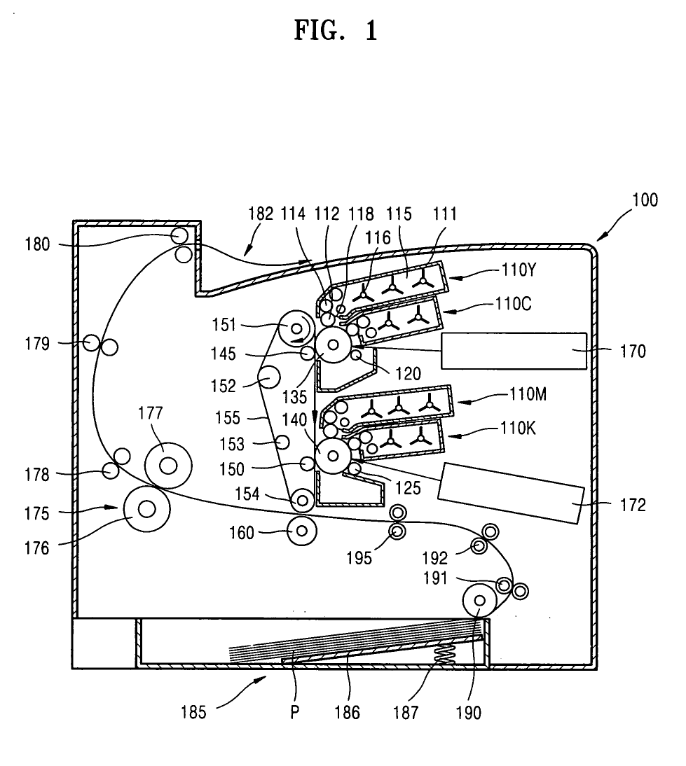

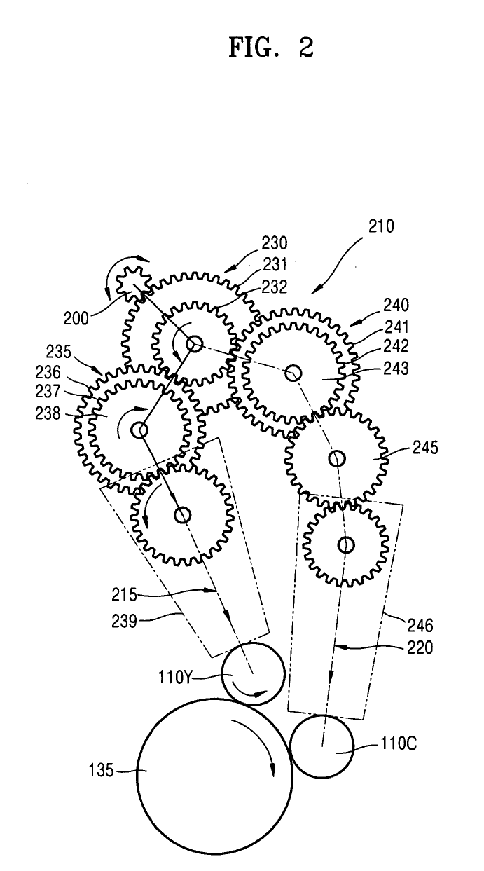

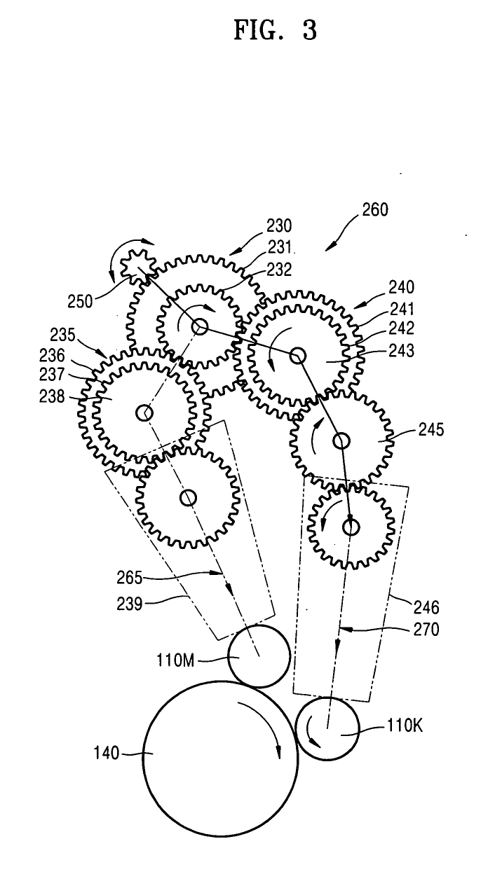

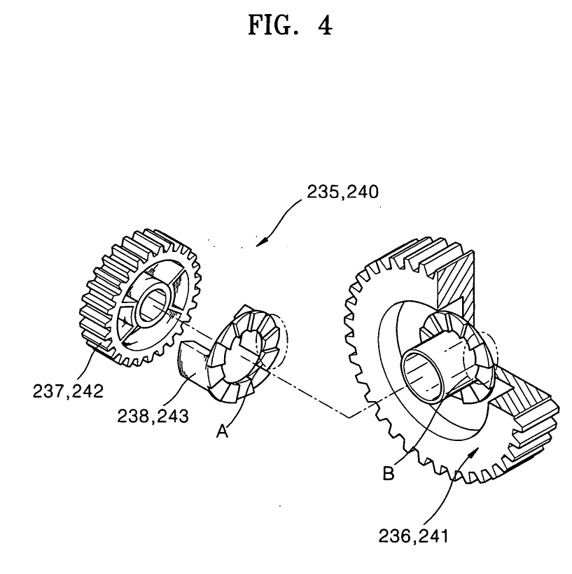

FIG. 1 is a cross-sectional view of a two-pass image forming apparatus according to an embodiment of the present invention. FIGS. 2 and 3 are cross-sectional views of a device for driving developers according to an embodiment of the present invention. FIG. 4 is a perspective view of one-way power transmission units shown in FIGS. 2 and 3.

In general, the two-pass image forming apparatus includes two exposure units and two photosensitive media. Referring to FIG. 1, an image forming apparatus 100 includes two laser scanning units (LSUs) 170 and 172, two photosensitive media 135 and 140, four developers 110Y, 110C, 110M, and 110K, first transfer units 145 and 150, an intermediate transfer belt 155, a second transfer unit 160, a fusing unit 175, a paper-feeding cassette 185, and a pickup roller 190. In the present embodiment, the developer 110Y for yellow (Y) and the developer 110C for cyan (C) are disposed around a first photosensitive medium 135, and the developer 110M for magenta (M) and the developer 110K for black (K) are disposed around a second photosensitive medium 140. Each of the LSUs 170 and 172 is disposed in each of the photosensitive media 135 and 140 and develops an electrostatic latent image by radiating light onto the photosensitive media 135 and 140. In the present embodiment, while the developers 110Y, 110C, 110M, and 110K and the photosensitive media 135 and 140 have been described as disposed in the above-described structure, the present invention is not limited to this but may be subject to various changes in form. The structure of the two-pass image forming apparatus will now be described.

The first and second LSUs 170 and 172 form an electrostatic latent image on an outer circumference of the photosensitive media 135 and 140 by radiating light corresponding to image information about colors such as yellow (Y), cyan (C), magenta (M), and black (K) onto the first and second photosensitive media 135 and 140 in response to a signal output from a computer. In the present embodiment, the LSUs use a laser diode as a light source.

Each of the developers 110Y, 110C, 110M, and 110K is mounted to be attached and detached to and from the image forming apparatus 100, like in a cartridge. Each of the developers 110Y, 110C, 110M, and 110K includes a housing 111 forming an outer shape, a developing roller 112 inside the housing 111, a supplying roller 114, a toner-holding unit 115, an agitator 116, and a toner layer regulating unit 118. A toner which is a developing agent is held in the toner-holding unit 115.

The developing roller 112 is installed in the first and second photosensitive media 135 and 140 in a contact or non-contact manner and supplies the toner held in the housing 111 to the first and second photosensitive media 135 and 140 by adhering the toner to outer circumferences of the first and second photosensitive media 135 and 140. The developing roller 112 holds a solid powdery toner and develops a toner image by supplying the toner to the electrostatic latent image formed on the first and second photosensitive media 135 and 140. A development bias voltage required for supplying the toner to the first and second photosensitive media 135 and 140 is applied to the developing roller 112. The developing roller 112 may be a developing roller coated with nickel (Ni) by performing sand blast treatment on an aluminum (Al) core or a developing roller which coats a stainless steel (SUS) shaft with rubber to a thickness of about 1.0 mm.

The supplying roller 114 supplies the toner to the developing roller 112 so that the toner is adhered to the developing roller 112. The agitator 116 agitates the toner at a predetermined speed so that the toner in the toner-holding unit 115 does not become hard, and transfers the toner to the supplying roller 114.

One side of the toner layer regulating unit 118 is fixed in the housing 111, and the other side thereof contacts the developing roller 112 so that the height of the toner adhered to the outer circumference of the developing roller 112 is regulated by the toner layer regulating unit 118 and the toner is friction-charged with a predetermined polarity. A metallic sheet material having elasticity may be used for the toner layer regulating unit 118.

The first and second photosensitive media 135 and 140 in which a photoconductive material layer is coated on an outer circumference of a cylinder-shaped metallic drum using methods such as deposition etc, are rotated in a predetermined direction and installed so that a portion of the outer circumference of the metallic drum is exposed to the outer circumferences of the first and second photosensitive media 135 and 140. The first and second photosensitive media 135 and 140 are charged by first and second charging rollers 120 and 125 to a predetermined electric potential, and an electrostatic latent image corresponding to an image to be printed is formed on the outer circumference of the metallic drum by light irradiated by the first and second LSUs 170 and 172 in response to the signal output from the computer. The outer circumference exposed to the outer circumferences of the first and second photosensitive media 135 and 140 faces the intermediate transfer belt 155.

The first and second charging rollers 120 and 125 charge the outer circumferences of the first and second photosensitive media 135 and 140 to a uniform electric potential before the first and second photosensitive media 135 and 140 are exposed by the first and second LSUs 170 and 172. A charging bias voltage is applied to the first and second charging rollers 120 and 125 so that the outer circumferences of the first and second photosensitive media 135 and 140 are charged to the uniform electric potential. A corona discharger (not shown) instead of the first and second charging rollers 120 and 125 may be used.

One side of the intermediate transfer belt 155 is disposed to face the first and second photosensitive media 135 and 140, and the other side thereof is disposed to face the two first transfer units 145 and 150. The intermediate transfer belt 155 travels between the first and second photosensitive media 135 and 140 and the first transfer units 145 and 150 and is supported by a plurality of support rollers 151, 152, 153, and 154 and circulated.

The two first transfer units 145 and 150 are disposed to face the first and second photosensitive media 135 and 140 in the state where the intermediate transfer belt 155 is placed between the first transfer units 145 and 150 and the first and second photosensitive media 135 and 140. In the present embodiment, a transfer bias voltage having a polarity opposite to that of the toner image is applied to the first transfer units 145 and 150 so that the toner image developed on the first and second photosensitive media 135 and 140 is transferred onto the intermediate transfer belt 155. The toner image is transferred onto the intermediate transfer belt 155 by an electrostatic force that acts between the first and second photosensitive media 135 and 140 and the first transfer units 145 and 150. The toner image developed on the outer circumferences of the first and second photosensitive media 135 and 140 may be transferred onto the intermediate transfer belt 155 that passes between the first and second photosensitive media 135 and 140 and the first transfer units 145 and 150 by contact pressure generated between the first and second photosensitive media 135 and 140 and the first transfer units 145 and 150.

The second transfer unit 160 is disposed to face the support roller 154 in the state where a transfer path through which a paper P passes is placed between the second transfer unit 160 and the support roller 154. In the present embodiment, a transfer bias voltage having a polarity opposite to that of the toner image is applied to the second transfer unit 160 so that the toner image that has been primarily transferred onto the intermediate transfer belt 155 is transferred onto the paper P. The toner image is transferred onto the paper P by an electrostatic force that acts between the intermediate transfer belt 155 and the second transfer unit 160.

The fusing unit 175 includes a heating roller 176 and a pressing roller 177 installed to face the heating roller 176. The fusing unit 175 fuses the toner image on the paper P by applying heat and pressure to the toner image that has been transferred onto the paper P. The heating roller 176 has a heat source for permanently sticking the toner image to the paper P. The heating roller is installed to face the pressing roller 177 in an axial direction. The pressing roller 177 is installed to face the heating roller 176 and fuses the toner image on the paper P by applying high pressure to the paper P.

A decurl unit 178 eliminates curl produced in the paper P by heat when the paper P passes through the fusing unit 175. Paper discharging rollers 179 and 180 discharge the paper P on which a fusing operation has been completed, outside the image forming apparatus 100. The paper P discharged outside the image forming apparatus 100 is stacked on a paper discharging unit 182.

In addition, the image forming apparatus 100 includes a paper-feeding cassette 185 which is disposed on a lower portion of the image forming apparatus 100 and on which the paper P is stacked. The paper-feeding cassette 185 includes a stacking portion 186 on which the paper P is stacked and an elastic portion 187 that elastically biases the stacking portion 186 toward a pickup roller 190 which will be described later. The pickup roller 190 picks up a sheet of paper P stacked on the stacking portion 186 and draws the sheet of paper P. Feed rollers 191 and 192 provide a transfer force needed to transfer the picked-up paper P to a registration roller 195.

The registration roller 195 aligns the paper P so that the toner image can be transferred to a desired portion of the paper P before the paper P passes between the support roller 154 and the second transfer unit 160. The paper P transferred by the registration roller 195 is transferred up to the front of a transfer nip of the second transfer unit 160 and passes between the support roller 154 and the second transfer unit 160, and the toner image formed on the intermediate transfer belt 155 is secondarily transferred onto the paper P and then, an image is formed.

The operation of the image forming apparatus shown in FIG. 1 according to an embodiment of the present invention will now be described.

The first and second photosensitive media 135 and 140 are charged by the charging bias voltage applied to the first and second charging rollers 120 and 125 to a uniform electric potential. The first and second LSUs 170 and 172 radiate light corresponding to image information about colors such as yellow (Y) and magenta (M) of an image onto the first and second photosensitive media 135 and 140. If light is scanned by the first and second LSUs 170 and 172, only a scanned portion is selectively erased such that an electric potential is reduced, and an output pattern formed by this potential difference is an electrostatic latent image.

The toner held in the toner-holding unit 115 is agitated by the agitator 116 and is supplied to the developing roller 112 to which the development bias voltage is applied by the supplying roller 114. The toner adhered to the outer circumference of the developing roller 112 is spread to a uniform thickness by the toner layer regulating unit 118. In this case, the toner is friction-charged by the developing roller 112 and the toner layer regulating unit 118.

If the electrostatic latent image becomes close to the developer 110Y while the first photosensitive medium 135 is rotated in a predetermined direction, the developing roller 112 of the developer 110Y begins to rotate. In this case, the development bias voltage is applied to the developer 110Y. Then, the toner of a yellow (Y) color is adhered to the electrostatic latent image formed on the outer circumference of the first photosensitive medium 135 so that a yellow (Y) toner image is formed.

If because of rotation of the first photosensitive medium 135, the yellow (Y) toner image is close to the intermediate transfer belt 155 rotating in a predetermined direction, due to the transfer bias voltage applied to the first transfer unit 145 and/or contact pressure generated between the first photosensitive medium 135 and the first transfer unit 145, the toner image is transferred to the intermediate transfer belt 155.

If the yellow (Y) toner image is completely transferred onto the intermediate transfer belt 155, the intermediate transfer belt 155 is continuously transferred to the second photosensitive medium 140. As described above, a magenta (M) toner image is developed on the outer circumference of the second photosensitive medium 140 and overlappedly transferred onto the intermediate transfer belt 155. If the transfer operation of the yellow (Y) toner image and the magenta (M) toner image is completed in this way, the intermediate transfer belt 155 is rotated.

Next, a cyan (C) toner image and a black (K) toner image are overlappedly transferred onto the intermediate transfer belt 155 after undergoing the above-described procedures. If all of toner images having four colors are overlappedly transferred onto the intermediate transfer belt 155 and a toner image is formed on the intermediate transfer belt 155 as described above, the toner image is transferred onto the paper P.

The paper P is drawn out from the paper-feeding cassette 185 by the pickup roller 190. The paper P is transferred by the feed rollers 191 and 192, fed and aligned by the registration roller 195 and passes between the support roller 154 and the second transfer unit 160. The paper P is transferred in such a manner that a front end of the paper P to be printed reaches the transfer nip when a front end of a color toner image formed on the intermediate transfer belt 155 reaches a position in which the second transfer unit 160 and the support roller 154 contacts each other.

If the paper P passes between the intermediate transfer belt 155 and the second transfer unit 160, the toner image formed on the intermediate transfer belt 155 is transferred onto the paper P by the transfer bias voltage applied to the second transfer unit 160.

The toner that remains on the outer circumference of the intermediate transfer belt 155 after the above-described transfer operation is completed, is removed by a cleaning member (not shown) and accumulated in a waste toner-holding unit (not shown). The fusing unit 175 fuses the toner image on the paper P by applying heat and pressure to the toner image formed on the paper P after the above-described transfer operation is completed. The decurl unit 178 eliminates curl produced in the paper P when the paper P passes through the fusing unit 175. The paper P that has passed through the decurl unit 178 is discharged outside the image forming apparatus 100 by the paper discharging roller 180 and stacked on the paper discharging unit 182. In the two-pass image forming apparatus 100, the intermediate transfer belt 155 is double-rotated to correspond to double rotation of the first and second photosensitive media 135 and 140 and then, the toner image is transferred onto the paper P.

A device for driving developers according to an embodiment of the present invention will now be described in detail.

Referring to FIGS. 2 and 3, the device for driving developers includes a plurality of developers 110Y, 110C, 110M, and 110K, driving sources 200 and 250, and power transmission units 210 and 260. As shown in FIGS. 2 and 3, the device for driving the developers 110Y and 110C disposed around the first photosensitive medium 135 and the device for driving the developers 110M and 110K disposed around the second photosensitive medium 140 have the same structure and operation. Thus, components of the power transmission units 210 and 260 that will be described later will be referred to with the same reference numerals.

In the present embodiment, the yellow and cyan developers 110Y and 110C are disposed around the first photosensitive medium 135 and the magenta and black developers 110M and 110K are disposed around the second photosensitive medium 140. While the developers 110Y, 110C, 110M, and 110K and the photosensitive media 135 and 140 have been described as disposed in the above-described structure, the present invention is not limited to this but may be subject to various changes in form.

The plurality of developers 110Y, 110C, 110M, and 110K develop toner images by supplying a toner which is a developing agent to each electrostatic latent image formed on the first and second photosensitive media 135 and 140. The first and second driving sources 200 and 250 are rotated forward and backward and drive the plurality of developers 110Y, 110C, 110M, and 110K disposed around the first and second photosensitive media 135 and 140. Here, forward and backward rotation means clockwise and counterclockwise rotation, that is, rotation in opposite directions. In the present embodiment, the driving sources include the first driving source 200 which selectively drives the two developers 110Y and 110M disposed around the first photosensitive medium 135 and the second driving source 250 which selectively drives the two developers 110C and 110K disposed around the second photosensitive medium 140. However, the present invention is not limited to this because the four developers 110Y, 110C, 110M, and 110K can be driven by using only one driving source.

A rotating force is transmitted from the driving sources 200 and 250 to the power transmission units 210 and 260, and the power transmission units 210 and 260 transmit a rotating force to the plurality of developers 110Y, 110C, 110M, and 110K disposed around the first and second photosensitive media 135 and 140. The power transmission units 210 and 260 include a first power transmission unit 210 to which a rotating force is transmitted from the first driving source 200 shown in FIG. 2 and a second power transmission unit 260 to which a rotating force is transmitted from the second driving source 250 shown in FIG. 3. A rotating force is transmitted from the first driving source 200 to the first power transmission unit 210, and the first power transmission unit 210 selectively drives one of the two developers 110Y and 110C disposed around the first photosensitive medium 135. The first driving source 200 separately drives the two developers 110Y and 110C disposed around the first photosensitive medium 135 by forward and backward rotation and transmits a rotating force in a direction 215 of the yellow developer 110Y and a direction 220 of the cyan developer 110C.

A rotating force is transmitted from the second driving source 250 to the second power transmission unit 260 to selectively drive one developer of the two developers 110M and 110K disposed around the second photosensitive medium 140. The second driving source 250 separately drives the two developers 110M and 110K disposed around the second photosensitive medium 140 by forward and backward rotation and transmits a rotating force in a direction 265 of the magenta developer 110M and a direction 270 of the black developer 110K. In the present embodiment, the first and second power transmission units 210 and 260 selectively drive only one developer of the plurality of developers 110Y, 110C, 110M, and 110K disposed around the first and second photosensitive media 135 and 140 in a direction in which the developer rotates. However, the present invention is not limited to this because the plurality of developers 110Y, 110C, 110M, and 110K can be simultaneously driven.

The first and second power transmission units 210 and 260 include a deceleration portion, a plurality of one-way power transmission units 235 and 240, and first and second power transmission members 239 and 246. The deceleration portion is geared with the first and second driving sources 200 and 250 and rotated and may be a deceleration gear 230. In the present embodiment, the deceleration gear 230 is a two-step gear and includes a gear 231 which is geared with the first and second driving sources 200 and 250 and to which a rotating force is transmitted, and a gear 232 which transmits a rotating force to the one-way power transmission units 235 and 240.

The one-way power transmission units 235 and 240 correspond to each of the developers 110Y, 110C, 110M, and 110K. The one-way power transmission units 235 and 240 are geared with the deceleration gear 230 and rotated and transmit a rotating force in only one direction in which the one-way power transmission units 235 and 240 rotate, by a rotating force transmitted from the deceleration gear 230. In the present embodiment, a rotating force is transmitted to the two one-way power transmission units 235 and 240 while they are engaged with the deceleration gear 230, and the two one-way power transmission units 235 and 240 are disposed to transmit a rotating force in opposite directions. That is, if the power transmission unit 235 which transmits a rotating force in the direction 215 of the yellow developer 110Y transmits a rotating force only clockwise (CW), the one-way power transmission unit 240 which transmits a rotating force in the direction 220 of the cyan developer 110C is disposed to transmit a rotating force only counterclockwise (CCW).

Referring to FIG. 4, the one-way power transmission units 235 and 240 include first gears 236 and 241, second gears 237 and 242, and hub clutches 238 and 243 disposed between the first gears 236 and 241 and the second gears 237 and 242. The first gears 236 and 241 are driven by the deceleration gear 230 and rotated forward and backward as the first and second driving sources 200 and 250 are rotated forward and backward. The second gears 237 and 242 are installed on the same shaft as that of the first gears 236 and 241 and transmit a rotating force to the developers 110Y, 110C, 110M, and 110K. The hub clutches 238 and 243 are disposed between the first gears 236 and 241 and the second gears 237 and 242 and transmit a rotating force to the second gears 237 and 242 only when the first gears 236 and 241 are rotated in one direction. Protrusions A and B, which are slanted to correspond to each other, are formed on inner surfaces of each of the first gears 236 and 241 and on one end of each of the hub clutches 238 and 243 which correspond to the inner surfaces of each of the first gears 236 and 241. When the first gears 236 and 241 are rotated in one direction, the one-way power transmission units 235 and 240 do not transmit a rotating force generated by the first gears 236 and 241 to the second gears 237 and 242 while the protrusion A formed on the hub clutches 238 and 243 goes over the protrusion B formed on the first gears 236 and 241. When the first gears 236 and 241 are rotated in an opposite direction on the contrary, the one-way power transmission units 235 and 241 transmit a rotating force generated by the first gears 236 and 241 to the second gears 237 and 242 while the protrusion A formed on the hub clutches 238 and 243 is engaged with the protrusion B formed on the first gears 236 and 241. By the same principle, the one-way power transmission units 235 and 240 transmit a rotating force only in one direction.

Referring to FIGS. 2 and 3, idle gears 245 are additionally installed in the one-way power transmission units 235 and 240 which transmit a rotating force in the direction 220 of the cyan developer 110C and the direction 270 of the black developer 110K, unlike in the one-way power transmission units 235 and 240 which transmit a rotating force in the direction 215 of the yellow developer 110Y and the direction 265 of the magenta developer 110M. Thus, the number of gears which transmit a rotating force from the first driving source 200 to one of the two developers 110Y or 110C disposed around the first photosensitive medium 135 is an even number and the number of gears which transmit a rotating force from the first driving source 200 to the other developer is an odd number. The number of gears which transmit a rotating force from the second driving source 250 to one of the two developers 110M or 110K disposed around the second photosensitive medium 140 is an even number and the number of gears which transmit a rotating force from the second driving source 250 to the other developer is an odd number. This is because the developing roller 112 disposed in each of the developers 110Y, 110C, 110M, and 110K is rotated in a predetermined direction and supplies toner to the first and second photosensitive media 135 and 140 that rotate in a predetermined direction.

The first and second power transmission members 239 and 246 transmit a rotating force to each of the developers 110Y, 110C, 110M, and 110K by a rotating force transmitted from the one-way power transmission unit 235 or the idle gear 245. A power transmission method using the first and second power transmission members 239 and 246 includes a power transmission method using gears or a power transmission method using coupling.

While the intermediate transfer belt 155 is rotated, the first and second driving sources 200 and 250 drive the yellow developer 110Y and the magenta developer 110M in the same direction. In addition, the second driving source 250 may operate after a predetermined amount of time after the first driving source 200 operates. When the first and second driving sources 200 and 250 are rotated forward, only one of the developers 110Y and 110M disposed around the first and second photosensitive media 135 and 140 may be driven. When the first and second driving sources 200 and 250 are rotated backward, only one of the other developers 110C and 110K disposed around the first and second photosensitive media 135 and 140 may be driven.

If a transfer operation from the first photosensitive medium 135 to the intermediate transfer belt 155 is completed or a development operation by the developers 110Y and 110C disposed around the first photosensitive medium 135 is completed, driving of the first driving source 200 can stop earlier than the second driving source 250 so that toner stress or other unnecessary rotation can be prevented. That is, the developers 110Y and 110C are driven only in a section in which the development operation is performed. After yellow and magenta images are developed and transferred onto the intermediate transfer belt 155 in an initial state, the second driving source 250 can stop until the intermediate transfer belt 155 is rotated and a black image is developed on the second photosensitive medium 140. In other words, driving of the first and second driving sources 200 and 250 may stop in a non-development section in which the development operation is completed, and when driving of the first and second driving sources 200 and 250 stops, a development bias voltage applied to the development roller 112 disposed in each of the developers 110C, 110M, 110Y, and 110K may be interrupted. Each of the first and second driving sources 200 and 250 may be separated from driving sources (not shown) for the photosensitive media 135 and 140 so that effects caused by oscillation or shock do not occur in each of the first and second driving sources 200 and 250.

Motor port and driver for operating the first and second driving sources 200 and 250 will be described later.

The operation of the device for driving developers according to an embodiment of the present invention will now be described.

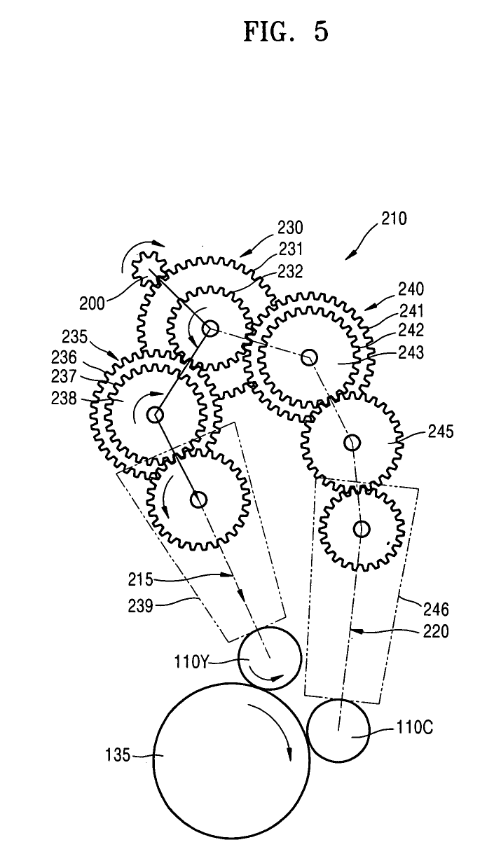

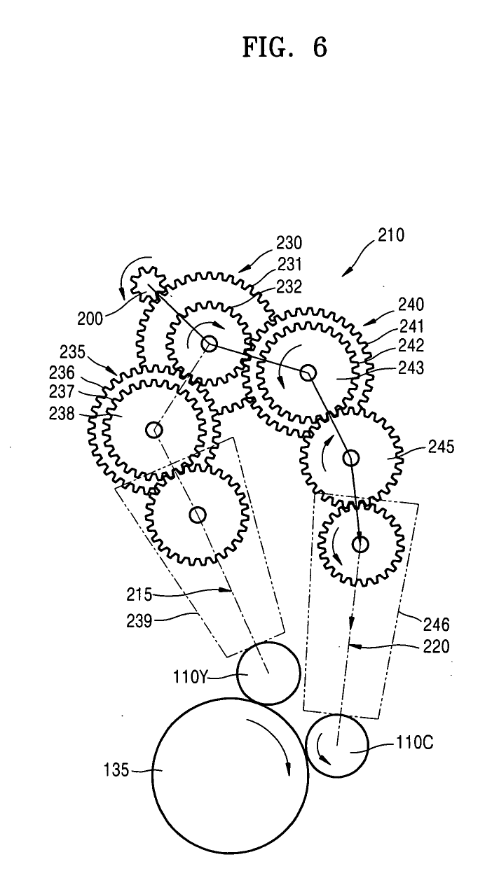

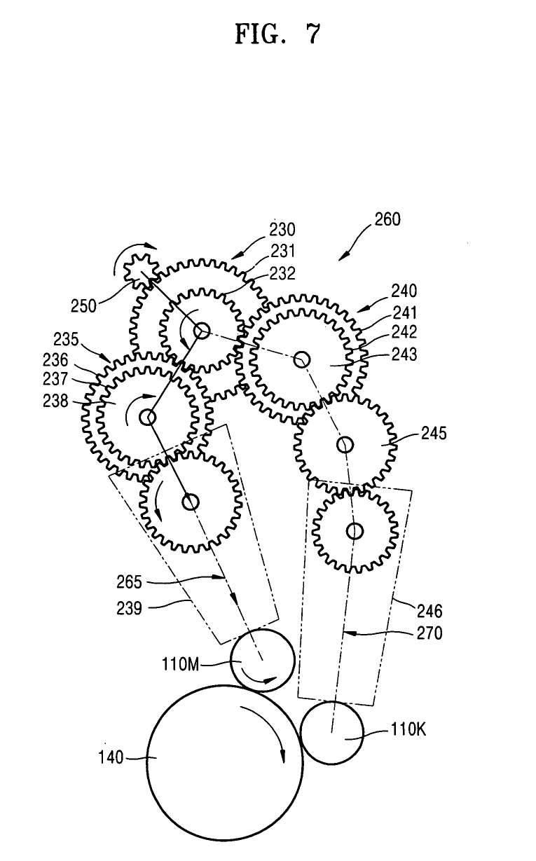

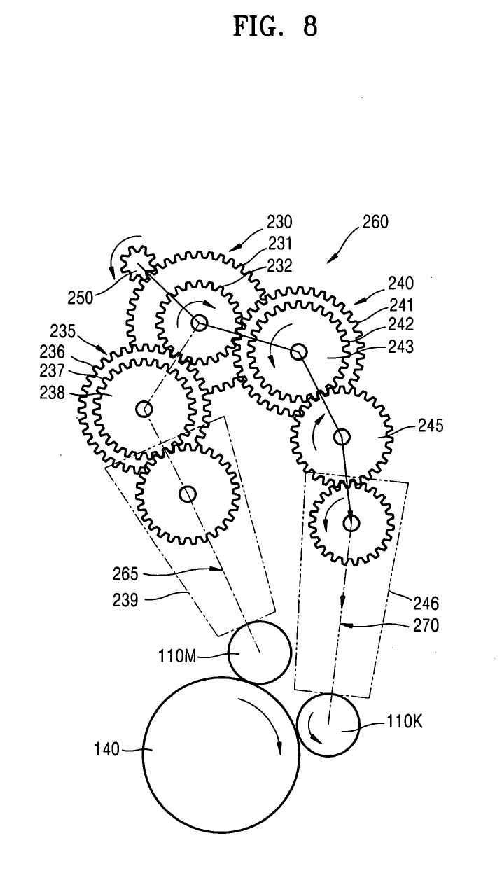

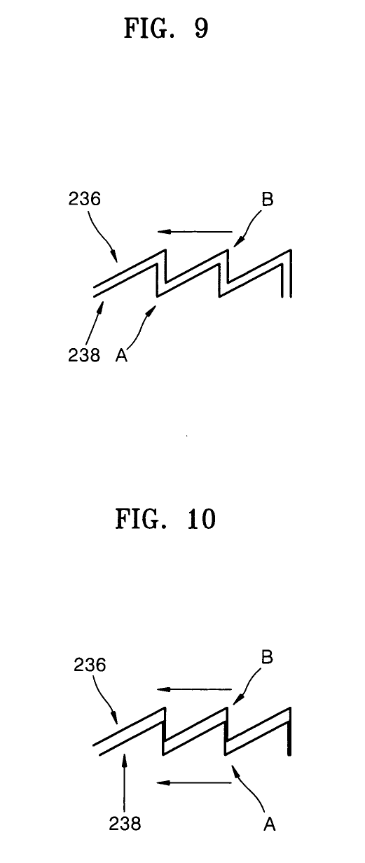

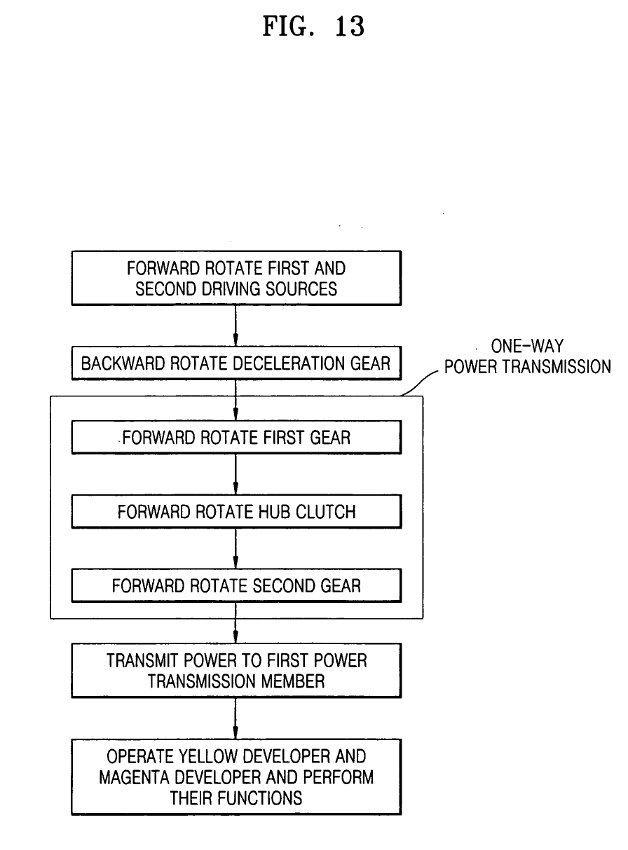

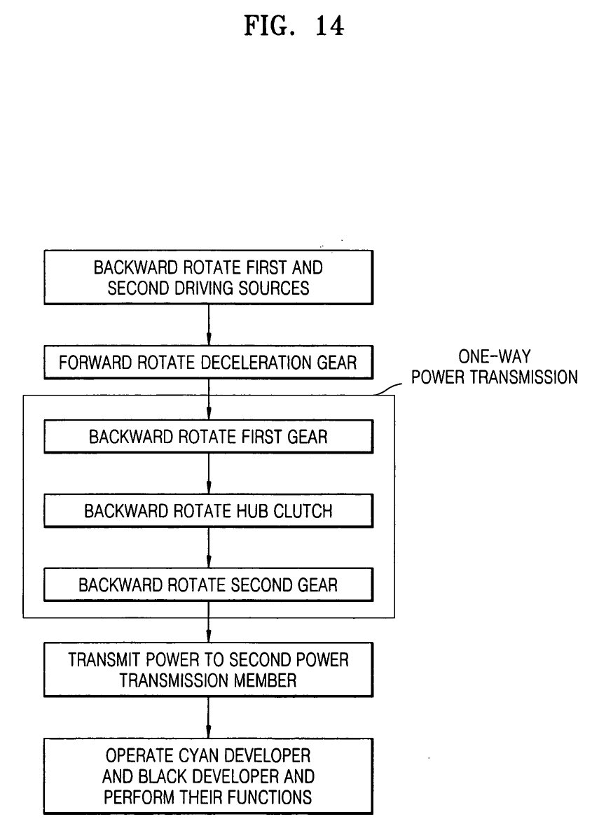

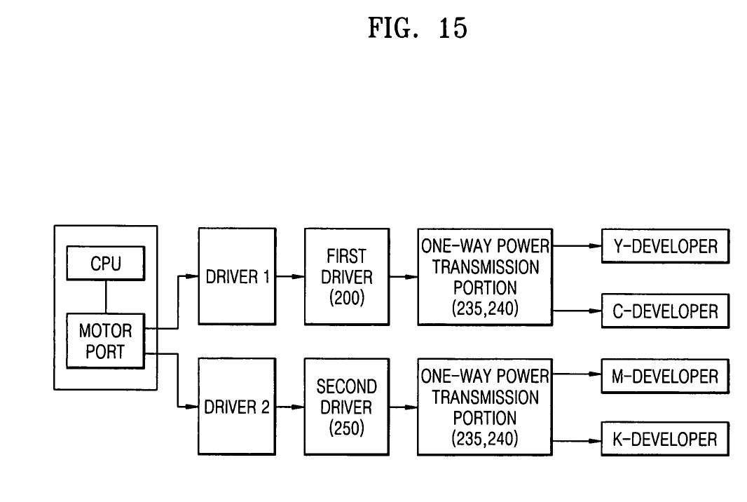

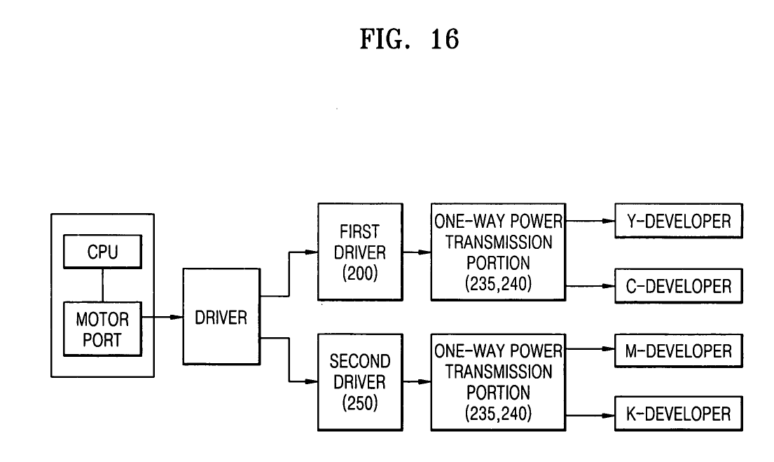

FIGS. 5 and 6 show the operation of the device for driving developers shown in FIG. 2, FIGS. 7 and 8 show the operation of the device for driving developers shown in FIG. 3, FIGS. 9 through 12 show the operation of the one-way power transmission units 235 and 240, FIGS. 13 and 14 are flowcharts illustrating the operation of the device for driving developers, and FIGS. 15 and 16 show the operation of the driving sources and developers when one driver for driving the driving sources is disposed and when two drivers for driving the driving sources are disposed. For explanatory convenience, a direction in which the first and second driving sources 200 and 250 are rotated forward is referred to as clockwise (CW) and a direction opposite to the direction is referred to as counterclockwise (CCW).

Referring to FIG. 1, in the two-pass image forming apparatus 100, a yellow color is developed on the first photosensitive medium 135 and then, a magenta color is developed on the second photosensitive medium 140. A toner image developed on each of the first and second photosensitive media 135 and 140 is transferred onto the intermediate transfer belt 155 at a predetermined time interval so that image registration is implemented. Simultaneously, the intermediate transfer belt 155 is continuously rotated and one cycle is finished, and then, the toner image reaches the first photosensitive medium 135. In this case, a cyan color developed on the first photosensitive medium 135 is transferred onto the intermediate transfer belt 155, and a black color developed on the second photosensitive medium 140 is transferred onto the intermediate transfer belt 155. After two cycles are finished in this way, the toner image that has been overlappedly transferred onto the intermediate transfer belt 155 is transferred onto the paper P.

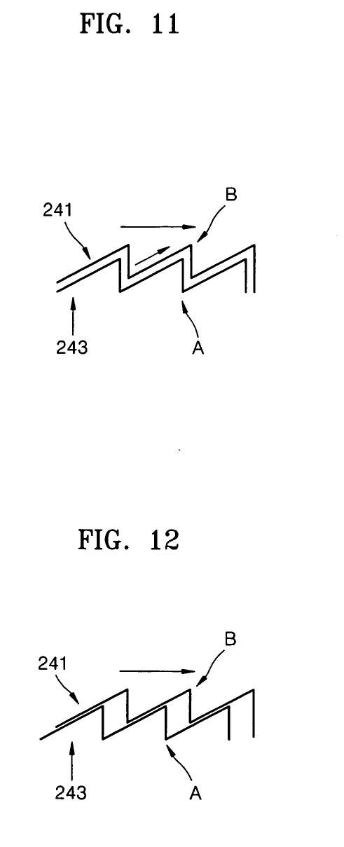

Referring to FIGS. 5 and 7, when the intermediate transfer belt 155 is rotated, the first and second driving sources 200 and 250 are rotated forward (CW) and transmit a rotating force to the deceleration gear 230. The deceleration gear 230 is rotated counterclockwise (CCW) and transmits a rotating force to the one-way power transmission units 235 and 240. The one-way power transmission units 235 and 240 driven by the deceleration gear 230 are disposed to transmit a rotating force in opposite directions. That is, when the first and second driving sources 200 and 250 are rotated forward (CW), as shown in FIGS. 9 and 10, the one-way power transmission unit 235 which transmits a rotating force in the direction 215 of the yellow developer 110Y and the direction 265 of the magenta developer 110M, transmits a rotating force generated by the first gear 236 to the second gear 237 while the protrusion A formed on the hub clutch 238 and the protrusion B formed on the first gear 236 are engaged with each other. On the contrary, as shown in FIGS. 11 and 12, the one-way power transmission unit 240 which transmits a rotating force in the direction 220 of the cyan developer 110C and the direction 270 of the black developer 110K, does not transmit a rotating force generated by the first gear 241 to the second gear 242 while the protrusion B formed on the first gear 241 goes over the protrusion A formed on the hub clutch 243. When the intermediate transfer belt 155 is rotated in this way, only the yellow developer 110Y and the magenta developer 110M operate so that the toner image is formed on the electrostatic latent image formed on the first and second photosensitive media 135 and 140.

When the intermediate transfer belt 155 is double-rotated, as shown in FIGS. 6 and 8, only the cyan developer 110C and the black developer 110K operate after undergoing procedures opposite to the above-described procedures, so that the toner image is formed on the electrostatic latent image formed on the first and second photosensitive media 135 and 140.

FIGS. 13 and 14 are flowcharts illustrating the operation of the device for driving developers when the first and second driving sources 200 and 250 are rotated forward and backward, as described above.

Referring to FIG. 13, when the first and second driving sources 200 and 250 are rotated forward, the deceleration gear 230 is rotated backward. As the deceleration gear 230 is rotated backward, the one-way power transmission units 235 and 240 are rotated forward and transmit a rotating force in only the direction 215 of the yellow developer 110Y and the direction 265 of the magenta developer 110M. When the first gear 236 is rotated forward and the protrusion B formed on the first gear 236 is engaged with the protrusion A formed on the hub clutch 238 and rotated, a rotating force is transmitted to the second gear 237. The first power transmission member 239 operates the yellow developer 110Y and the magenta developer 110M by a rotating force transmitted from the second gear 237 so that the toner is supplied to the electrostatic latent image formed on the first and second photosensitive media 135 and 140 and the toner image is developed.

Referring to FIG. 14, when the first and second driving sources 200 and 250 are rotated backward, the deceleration gear 230 is rotated forward. As the deceleration gear 230 is rotated forward, the one-way power transmission units 235 and 240 are rotated backward and a rotating force is transmitted in only the direction 220 of the cyan developer 110C and the direction 270 of the black developer 110K. When the first gear 241 is rotated forward and the protrusion B formed on the first gear is engaged with the protrusion A formed on the hub clutch 243 and rotated, a rotating force is transmitted to the second gear 242. The second power transmission member 246 operates the cyan developer 110C and the black developer 110K by a rotating force transmitted from the second gear 242 so that the toner is supplied to the electrostatic latent image formed on the first and second photosensitive media 135 and 140 and the toner image is developed.

Referring to FIG. 15, when the first and second driving sources 200 and 250 are driven, if the number of motor ports embedded in a central processing unit (CPU) are small, two drivers 1 and 2 can operate at one port. In this way, rotation directions and acceleration and deceleration sections of the first and second driving sources 200 and 250 are the same such that the number of motor ports in the CPU can be reduced. If necessary, the acceleration and deceleration sections of the first and second driving sources 200 and 250 are the same such that the first and second driving sources 200 and 250 can be simultaneously driven by using one driver, as shown in FIG. 16.

According to the above-described configuration, the two driving sources 200 and 250 are rotated forward and backward such that one developer and one photosensitive medium can be driven by using one driving source in a conventional single pass method.

The device for driving developers according to another embodiment of the present invention will now be described.

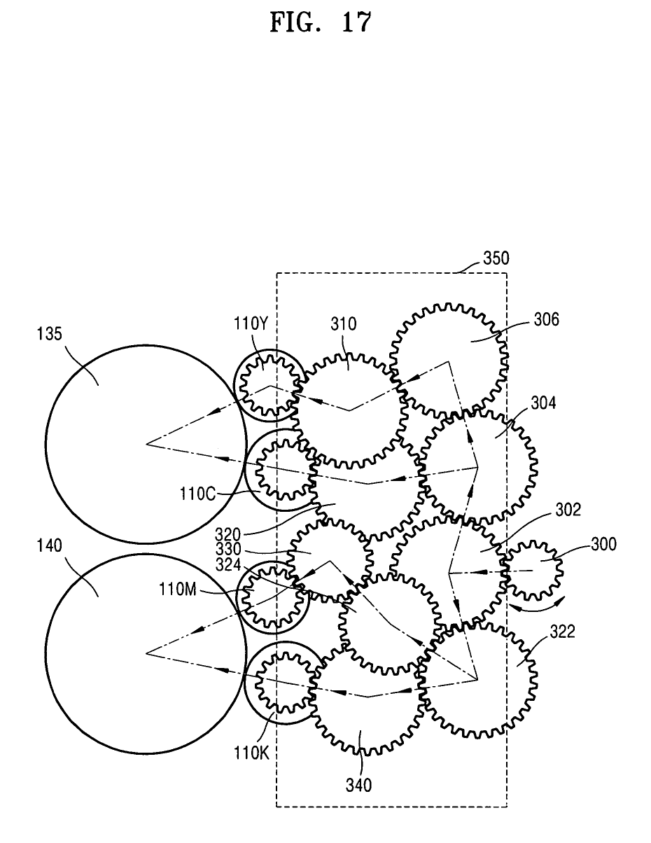

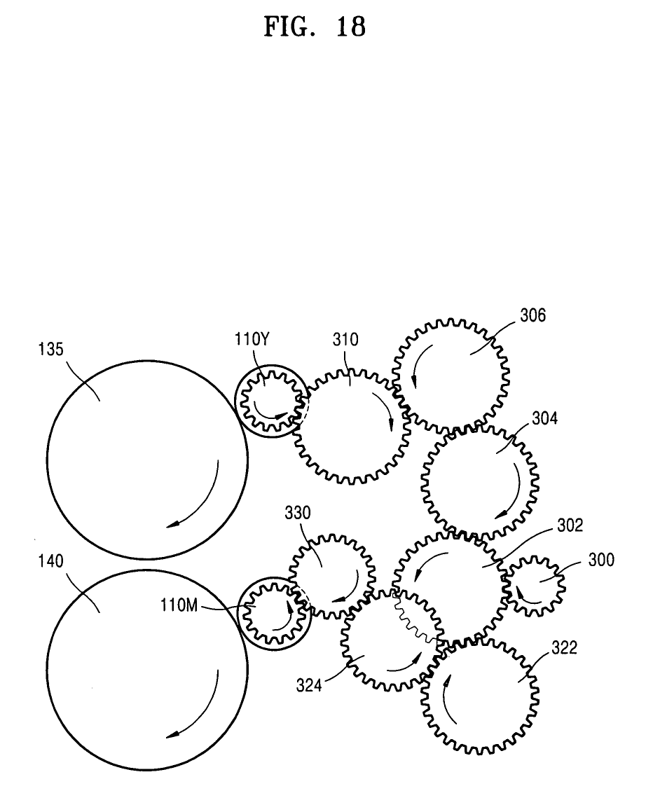

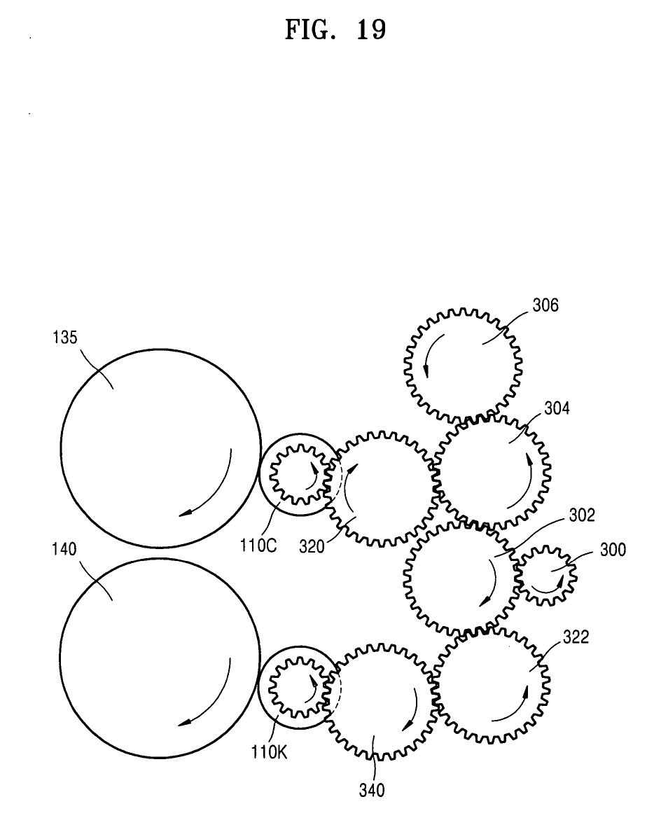

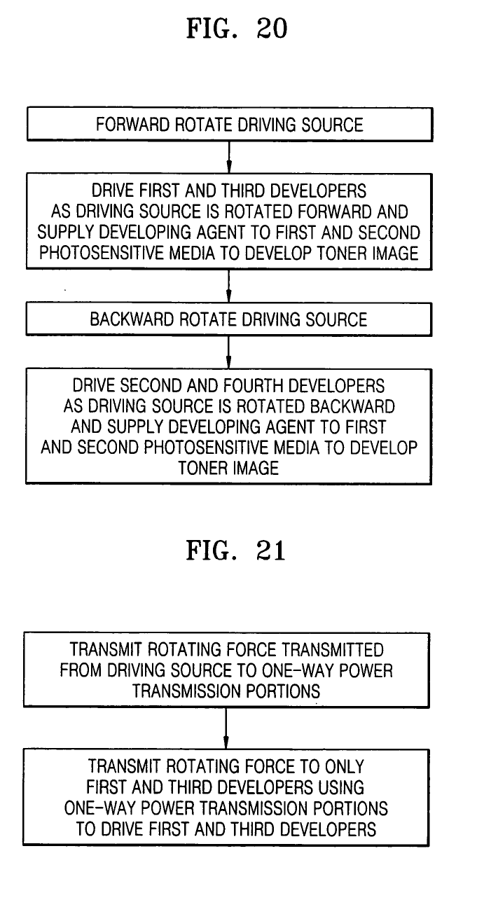

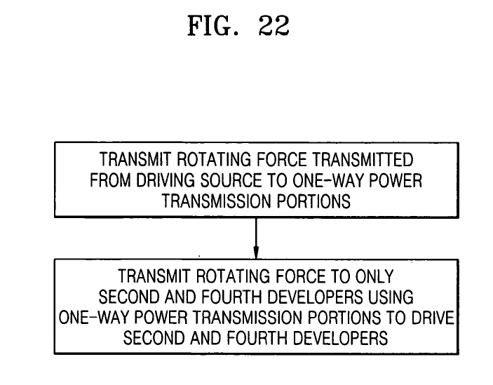

FIG. 17 is a cross-sectional view of the device for driving developers according to another embodiment of the present invention, and FIGS. 18 and 19 show the operation of the device for driving developers shown in FIG. 17. In addition, FIGS. 20 through 22 are flowcharts illustrating a method of driving the device for driving developers. The same reference numerals as those shown in FIG. 1 are used in the first and second photosensitive media 135 and 140 and the plurality of developers 110Y, 110C, 110M, and 110K.

Referring to FIG. 17, the device for driving developers according to another embodiment of the present invention comprise first, second, third, and fourth developers 110Y, 110C, 110M, and 110K, one driving source 300, and a power transmission unit 350.

The first and second developers 110Y and 110C are disposed around the first photosensitive medium 135 and supplies toner which is a developing agent to an electrostatic latent image formed on the first photosensitive medium 135 to develop a toner image. The third and fourth developers 110M and 110K are disposed around the second photosensitive medium 140 and supplies toner which is the developing agent to an electrostatic latent image formed on the second photosensitive medium 140 to develop a toner image.

The driving source 300 is driven by forward and backward rotation and drives the first, second, third, and fourth developers 110Y, 110C, 110M, and 110K according to their driving directions.

The power transmission unit 350 transmit a rotating force to the first, second, third, and fourth developers 110Y, 110C, 110M, and 110K by a rotating force transmitted from the driving source 300. When the driving source 300 is rotated forward, the power transmission unit 350 may drive the first and third developers 110Y and 110M, and when the driving source 300 is rotated backward, the power transmission unit 350 may drive the second and fourth developers 110C and 110K. In this case, the first, second, third, and fourth developers 110Y, 110C, 110M, and 110K are rotated in a predetermined direction regardless of forward and backward rotation of the driving source 300 and supply toner to the electrostatic latent images formed on the first and second photosensitive media 135 and 140. The power transmission unit 350 is installed to face the first, second, third, and fourth developers 110Y, 110C, 110M, and 110K and may include first, second, third, and fourth one-way power transmission portions 310, 320, 330, and 340 which transmit a rotating force in only one direction to each developer.

When the driving source 300 is rotated forward, the first, second, third, and fourth one-way power transmission portions 310, 320, 330, and 340 transmit a rotating force to the first and third developers 110Y and 110M, and when the driving source 300 is rotated backward, the first, second, third, and fourth one-way power transmission portions 310, 320, 330, and 340 transmit a rotating force to the second and fourth developers 110C and 110K. The configuration, operation, and effect of the first, second, third, and fourth one-way power transmission portions 310, 320, 330, and 340 are the same as those of the one-way power transmission portions 235 and 240 shown in FIG. 4, and thus, detailed descriptions thereof will be omitted.

As shown in FIG. 17, the power transmission unit includes a plurality of gears. The number of gears which transmit a rotating force to the first and third developers 110Y and 110M may be an even number and the number of gears which transmit a rotating force to the second and fourth developers 110C and 110K may be an odd number. Alternatively, the number of gears which transmit a rotating force to the first and third developers 110Y and 110M may be an odd number and the number of gears which transmit a rotating force to the second and fourth developers 110C and 110K may be an even number.

The operation of the device for driving developers according to another embodiment of the present invention will now be described. For explanatory conveniences, a direction in which the driving sources 300 is rotated forward is referred to as clockwise (CW) and a direction opposite to the direction is referred to as counterclockwise (CCW).

Referring to FIG. 18, when the driving source 300 is rotated forward, a first idle gear 302 is rotated backward, a second idle gear 304 is rotated forward (CW), and a rotating force is transmitted to the second one-way power transmission portion 320 and a third idle gear 306. The third idle gear 306 is rotated backward (CCW) and a rotating force is transmitted to the first one-way power transmission portion 310. Thus, since the first one-way power transmission portion 310 is rotated forward (CW), the first developer 110Y is driven, and since the second one-way power transmission portion 320 is rotated backward (CCW), a rotating force cannot be transmitted to the second developer 110C. When the driving source 300 is rotated forward (CW), the first idle gear 302 is rotated backward (CCW), the fourth idle gear 322 is rotated forward (CW), and a rotating force is transmitted to the fourth one-way power transmission portion 340 and a fifth idle gear 324. The fifth idle gear 324 is rotated backward (CCW), and a rotating force is transmitted to the third one-way power transmission portion 330. Thus, since the third one-way power transmission portion 330 is rotated forward (CW), the third developer 110M is driven, and since the fourth one-way power transmission portion 340 is rotated backward (CCW), rotating fore cannot be transmitted to the fourth developer 110K. That is, when the driving source 300 is rotated forward, only the first and third developers 110Y and 110M are driven.

Referring to FIG. 19, when the driving source 300 is rotated backward, the first idle gear 302 is rotated forward (CW), the second idle gear 304 is rotated backward (CCW), and a rotating force is transmitted to the second one-way power transmission portion 320 and the third idle gear 306. The third idle gear 306 is rotated forward (CW) and a rotating force is transmitted to the first one-way power transmission portion 310. Thus, since the first one-way power transmission portion 310 is rotated backward (CCW), a rotating force cannot be transmitted to the first developer 110Y, and since the second one-way power transmission portion 320 is rotated forward (CW), a rotating force is transmitted to the second developer 110C. When the driving source 300 is rotated backward (CCW), the first idle gear 302 is rotated forward (CW), the fourth idle gear 322 is rotated backward (CCW), and a rotating force is transmitted to the fourth one-way power transmission portion 340 and the fifth idle gear 324. The fifth idle gear 324 is rotated backward (CW), and a rotating force is transmitted to the third one-way power transmission portion 330. Thus, since the third one-way power transmission portion 330 is rotated backward (CCW), the third developer 110M cannot be driven, and since the fourth one-way power transmission portion 340 is rotated forward (CW), rotating fore is transmitted to the fourth developer 110K. That is, when the driving source 300 is rotated backward, only the second and fourth developers 110C and 110K are driven.

A method of driving the device for driving developers will now be described.

The driving source 300 is rotated forward (CW). A rotating force is transmitted from the driving source 300 to the power transmission unit 350. That is, a rotating force is transmitted from the driving source 300 to the one-way power transmission portions 310, 320, 330, and 340 of the power transmission unit 350. In this case, a rotating force is transmitted by the first and third one-way power transmission portions 310 and 330 to only the first and third developers 110Y and 110M so that the first and third developers 110Y and 110M are driven. Thus, the first and second developers 110Y and 110M supply toner which is a developing agent to the first and second photosensitive media 135 and 140 to develop a toner image.

Next, the driving source 300 is rotated backward (CCW). A rotating force is transmitted from the driving source 300 to the power transmission unit 350. That is, a rotating force is transmitted from the driving source 300 to the one-way power transmission portions 310, 320, 330, and 340 of the power transmission unit 350. In this case, a rotating force is transmitted by the second and fourth one-way power transmission portions 320 and 340 to only the second and fourth developers 110C and 110K so that the second and fourth developers 110C and 110K are driven. Thus, the second and fourth developers 110C and 110K supply toner which is a developing agent to the first and second photosensitive media 135 and 140 to develop a toner image.

According to the above-described configuration and method, one driving source 300 is rotated forward and backward so that four developers can be driven.

A device for driving developers according to still another embodiment of the present invention will now be described.

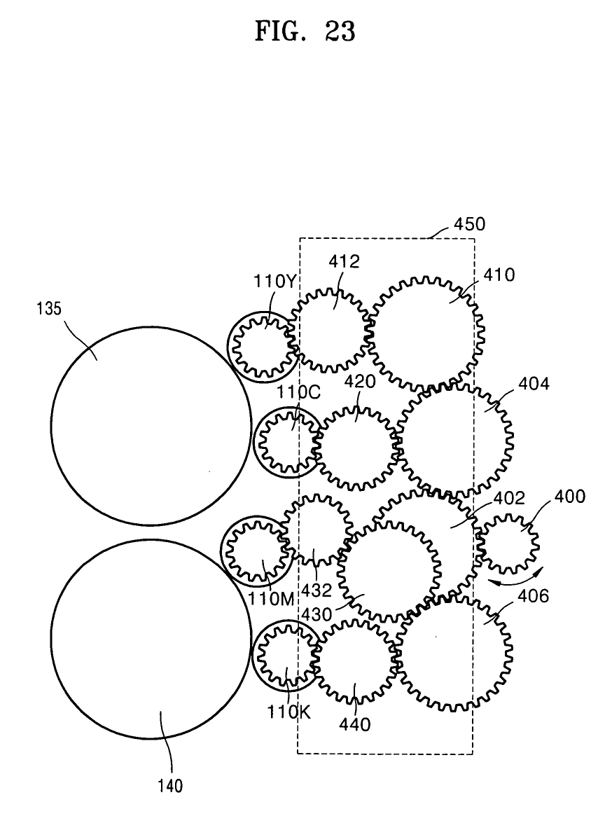

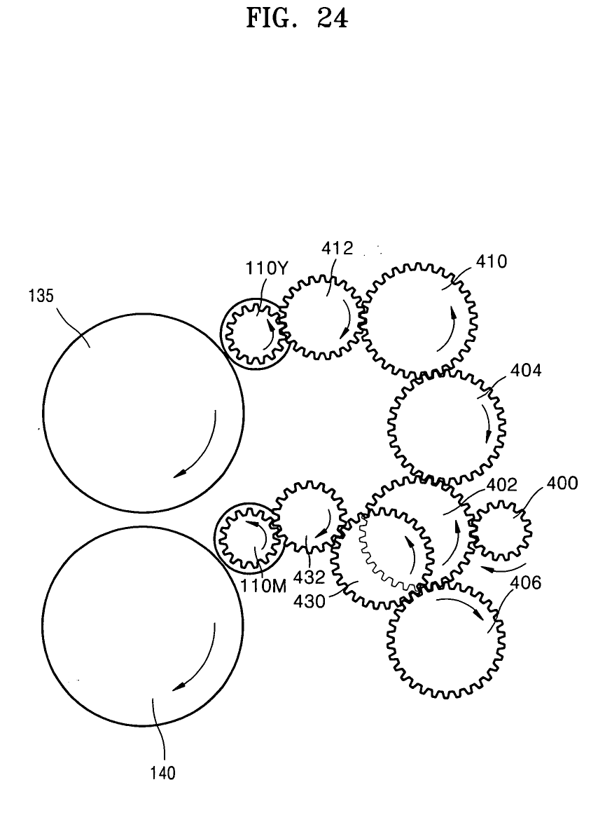

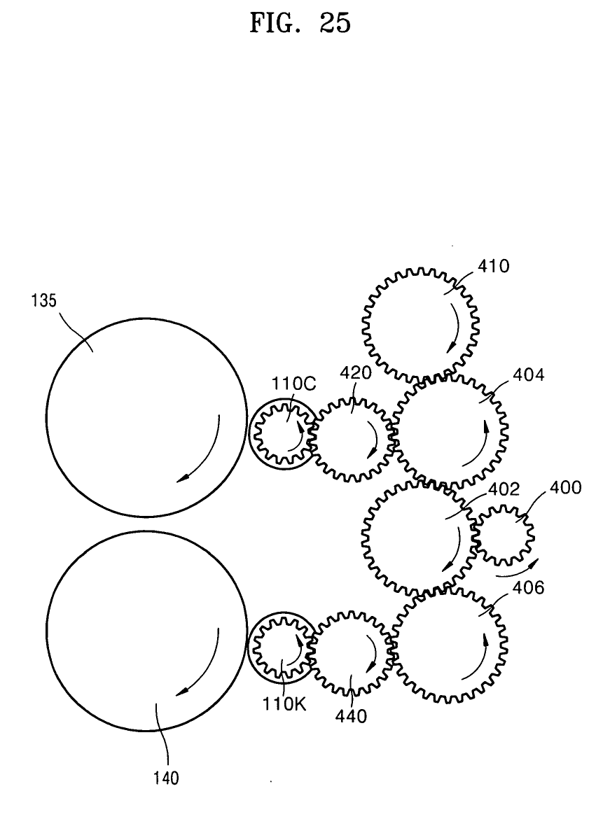

FIG. 23 is a cross-sectional view of the device for driving developers according to another embodiment of the present invention, and FIGS. 24 and 25 show the operation of the device for driving developers shown in FIG. 23. The same reference numerals as those shown in FIG. 1 are used in the first and second photosensitive media 135 and 140 and the plurality of developers 110Y, 110C, 110M, and 110K.

Referring to FIG. 23, the device for driving developers according to another embodiment of the present invention comprise first, second, third, and fourth developers 110Y, 110C, 110M, and 110K, a driving source 400, and a power transmission unit 450.

The first and second developers 110Y and 110C are disposed around the first photosensitive medium 135 and supply toner which is a developing agent to an electrostatic latent image formed on the first photosensitive medium 135 to develop a toner image. The third and fourth developers 110M and 110K are disposed around the second photosensitive medium 140 and supply toner that is a developing agent to an electrostatic latent image formed on the second photosensitive medium 140 to develop a toner image.

The driving source 400 is driven by forward and backward rotation and drives the first, second, third, and fourth developers 110Y, 110C, 110M, and 110K according to their driving directions.

The power transmission unit 450 transmits a rotating force to the first, second, third, and fourth developers 110Y, 110C, 110M, and 110K by a rotating force transmitted from the driving source 400. When the driving source 400 is rotated forward, the power transmission unit 450 may drive the first and third developers 110Y and 110M, and when the driving source 400 is rotated backward, the power transmission unit 450 may drive the second and fourth developers 110C and 110K. In this case, the first, second, third, and fourth developers 110Y, 110C, 110M, and 110K are rotated in a predetermined direction regardless of forward and backward rotation of the driving source 400 and supply toner to the electrostatic latent images formed on the first and second photosensitive media 135 and 140. The power transmission unit 450 may include first, second, third, and fourth one-way power transmission portions 410, 420, 430, and 440 which transmit a rotating force in only one direction to each developer.

When the driving source 400 is rotated forward, the first, second, third, and fourth one-way power transmission portions 410, 420, 430, and 440 transmit a rotating force to the first and third developers 110Y and 110M, and when the driving source 400 is rotated backward, the first, second, third, and fourth one-way power transmission portions 410, 420, 430, and 440 transmit a rotating force to the second and fourth developers 110C and 110K. Referring to FIG. 23, each of the first and second one-way power transmission portions 410 and 420 is engaged with the second idle gear 404 and each of the third and fourth one-way power transmission portions 430 and 440 is engaged with the fourth idle gear 406. The configuration, operation, and effect of the first, second, third, and fourth one-way power transmission portions 410, 420, 430, and 440 are the same as those of the one-way power transmission portions 235 and 240 shown in FIG. 4, and thus, detailed descriptions thereof will be omitted.

As shown in FIG. 23, the first one-way power transmission portion 410 is engaged with the third idle gear 412 and operates, the third idle gear 412 is engaged with the first developer 110Y and operates, and a rotating force is transmitted to the first developer 110Y. The second one-way power transmission portion 420 is engaged with the second idle gear 404 and rotated and transmits a rotating force to the second developer 110C. The third one-way power transmission portion 430 is engaged with the fifth idle gear 432 and operates, and the fifth idle gear 432 is engaged with the third developer 110M and rotated, and a rotating force is transmitted to the third developer 110M. The fourth one-way power transmission portion 440 is engaged with the fourth developer 110K and rotated and transmit a rotating force to the fourth developer 110K.

As shown in FIG. 23, the power transmission unit 450 includes a plurality of gears. The number of gears that transmit a rotating force to the first and third developers 110Y and 110M may be an even number and the number of gears which transmit a rotating force to the second and fourth developers 110C and 110K may be an odd number. Alternatively, the number of gears which transmit a rotating force to the first and third developers 110Y and 110M may be an odd number and the number of gears which transmit a rotating force to the second and fourth developers 110C and 110K may be an even number.

The operation of the device for driving developers according to still another embodiment of the present invention will now be described. For explanatory convenience, a direction in which the driving sources 400 is rotated forward is referred to as clockwise (CW) and a direction opposite to the forward direction is referred to as backward or counterclockwise (CCW).

Referring to FIG. 24, when the driving source 400 is rotated forward (CW), a first idle gear 402 is rotated backward (CCW), a second idle gear 404 is rotated forward (CW), and a rotating force is transmitted to the first and second one-way power transmission portions 410 and 420. Since the second one-way power transmission portion 420 does not transmit a rotating force when the driving source 400 is rotated backward, the first one-way power transmission portion 410 is rotated backward (CCW) and transmits a rotating force to the third idle gear 412. Thus, the third idle gear 412 is rotated forward (CW) and drives the first developer 110Y.

Simultaneously, when the driving source 400 is rotated forward (CW), the first idle gear 402 is rotated backward (CCW), a fourth idle gear 406 is rotated forward (CW), and a rotating force is transmitted to the third and fourth one-way power transmission portions 430 and 440. Since the fourth one-way power transmission portion 440 does not transmit a rotating force when the driving source 400 is rotated backward (CCW), the third one-way power transmission portion 430 is rotated backward (CCW) and transmits a rotating force to the fifth idle gear 432. Thus, the fifth idle gear 432 is rotated forward (CW) and drives the third developer 110M. That is, when the driving source 400 is rotated forward (CW), only the first and third developers 110Y and 110M are driven.

Referring to FIG. 25, when the driving source 400 is rotated backward (CCW), the first idle gear 402 is rotated forward (CW), the second idle gear 404 is rotated backward (CCW), and a rotating force is transmitted to the first and second one-way power transmission portion 410 and 420. Since the first one-way power transmission portion 410 does not transmit a rotating force when the driving source 400 is rotated forward, the second one-way power transmission portion 420 is rotated forward (CW) and transmits a rotating force to the third idle gear 412. Thus, the third idle gear 412 is rotated backward (CW) and drives the second developer 110Y.

Simultaneously, when the driving source 400 is rotated backward (CCW), the first idle gear 402 is rotated forward (CW), the fourth idle gear 406 is rotated backward (CCW), and a rotating force is transmitted to the third and fourth one-way power transmission portions 430 and 440. Since the third one-way power transmission portion 430 does not transmit a rotating force when the driving source 400 is rotated forward (CW), the fourth one-way power transmission portion 440 is rotated forward (CW) and drives the fourth developer 110K. That is, when the driving source 400 is rotated backward, only the second and fourth developers 110C and 110K are driven.

According to the above-described configuration and method, one driving source 400 is rotated forward and backward so that four developers can be driven.

As described above, in the device for driving developers, the image forming apparatus having the same, and the method of driving the device for driving developers according to the present invention, the following effects can be obtained. First, in a two-pass image forming apparatus, two developers are separately driven by forward and backward rotating one driving source such that image bending or deviation of registration caused by load change can be prevented. Second, the developers are driven by forward and backward rotating only the driving source such that noise can be prevented from occurring. Third, one or two driving sources are used such that four developers can be driven by using a driving source with small capacity or current and power consumption can be reduced. In addition, oscillation or shock that occurs when each developer contacts another developer can be prevented such that a high image quality can be kept. Fourth, since a driving source is driven in only a necessary section, toner stress caused by rotation of developers can be prevented such that an image quality can be improved and the life span of the apparatus can be lengthened. Fifth, one or two driving sources are used such that the apparatus can be simply configured and installation space can be obtained. Sixth, a plurality of developers are mechanically controlled such that costs for an electronic clutch and the number of controllers needed in the electronic clutch can be reduced.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A two-pass image forming apparatus having a first photosensitive medium and a second photosensitive medium, the apparatus comprising:
a plurality of developers supplying a developing agent to electrostatic latent images formed on the first photosensitive medium and the second photosensitive medium;
a driving source driving the plurality of developers and being rotated forward and backward; and
a power transmission unit transmitting a rotating force from the driving source to the plurality of developers, and
wherein two of the plurality of developers are disposed around each of the first photosensitive medium and the second photosensitive medium.

2. The apparatus of claim 1, wherein the driving source comprises:
a first driving source driving the two developers disposed around the first photosensitive medium; and
a second driving source driving the two developers disposed around the second photosensitive medium.

3. The apparatus of claim 2, wherein the power transmission unit comprises:
a first power transmission unit to which a rotating force is transmitted from the first driving source; and
a second power transmission unit to which a rotating force is transmitted from the second driving source, and
wherein one of the two developers disposed to face outer circumferences of the first photosensitive medium and the second photosensitive medium is selectively driven as the first and second driving sources are rotated forward and backward.

4. The apparatus of claim 3, wherein the first and second power
transmission units comprise a deceleration portion being geared with the first and second driving sources and being rotated, and
wherein the deceleration portion includes a deceleration gear.

5. The apparatus of claim 4, wherein the first and second power
transmission units comprise a plurality of one-way power transmission portions transmitting a rotating force in only one direction by a rotating force transmitted from the deceleration gear, and
wherein each of the one-way power transmission portions is disposed to transmit a rotating force in opposite directions.

6. The apparatus of claim 5, wherein the one-way power transmission portions comprise:
a first gear driven by the deceleration gear;
a second gear being installed on the same shaft as that of the first gear and transmitting a rotating force to a direction of the developer; and
a hub clutch being disposed between the first gear and the second gear and transmitting a rotating force to the second gear only when the first gear is rotated in one direction.

7. The apparatus of claim 6, wherein the first power transmission unit
comprises a plurality of gears, the number of gears transmitting a rotating force from the first driving source to one of the two developers is an even number and the number of gears transmitting a rotating force from the first driving source to the other developer is an odd number, and
wherein the second power transmission unit comprises a plurality of gears, the number of gears transmitting a rotating force from the second driving source to one of the two developers is an even number and the number of gears transmitting a rotating force from the second driving source to the other developer is an odd number.

8. The apparatus of claim 6, wherein the first and second driving sources are rotated in the same direction.

9. The apparatus of claim 6, wherein, when the first driving source is
rotated forward, the first driving source drives only one of the two developers disposed around the first photosensitive medium and when the first driving source is rotated backward, the first driving source drives only the other developer disposed around the first photosensitive medium.

10. The apparatus of claim 6, wherein, when the second driving source
is rotated forward, the second driving source drives only one of the two developers disposed around the second photosensitive medium and when the second driving source is rotated backward, the first driving source drives only the other developer disposed around the second photosensitive medium.

11. The apparatus of claim 6, wherein driving of the first and second
driving sources stops in a non-development section in which a development operation is completed.

12. The apparatus of claim 11, wherein, when driving of the first and
second driving sources stops in the non-development section, a development bias voltage applied to a developing roller disposed in each of the developers is interrupted.

13. A two-pass image forming apparatus having a first photosensitive medium and a second photosensitive medium, the apparatus comprising:
a first developer and a second developer each supplying a developing agent to an electrostatic latent image formed on the first photosensitive medium;
a third developer and a fourth developer each supplying a developing agent to an electrostatic latent image formed on the second photosensitive medium;
one driving source driving the developers and being rotated forward and backward; and
a power transmission unit transmitting a rotating force from the driving source to the developers, and
wherein, when the driving source is rotated forward, the power transmission unit drives the first and third developers and when the driving source is rotated backward, the power transmission unit drives the second and fourth developers.

14. The apparatus of claim 13, wherein the power transmission unit comprises:
first, second, third, and fourth one-way power transmission portions being installed to face the first, second, third, and fourth developers and transmitting a rotating force in only one direction of each of the developers, and
wherein, when the driving source is rotated forward, the one-way power transmission portions drive the first and third developers and when the driving source is rotated backward, the one-way power transmission portions drive the second and fourth developers.

15. The apparatus of claim 14, wherein the one-way power transmission portions comprise:
a first gear to which a rotating force is transmitted from the driving source;
a second gear being installed on the same shaft as that of the first gear and transmitting a rotating force to a direction of the developer; and
a hub clutch being disposed between the first gear and the second gear and transmitting a rotating force to the second gear only when the first gear is rotated in one direction.

16. The apparatus of claim 15, wherein the power transmission unit
comprises a plurality of gears, the number of gears transmitting a rotating force from the driving source to the first and third developers is an even number and the number of gears transmitting a rotating force from the driving source to the second and fourth developers is an odd number.

17. A method of driving a device for driving developers, the device comprising a first developer and a second developer each supplying a developing agent to an electrostatic latent image formed on a first photosensitive medium; a third developer and a fourth developer each supplying a developing agent to an electrostatic latent image formed on a second photosensitive medium; one driving source driving the developers and being rotated forward and backward; and a power transmission unit transmitting a rotating force from the driving source to the developers, wherein the method comprises:
forward rotating the driving source;
driving the first and third developers as the driving source is rotated forward and supplying the developing agent to the first photosensitive medium and the second photosensitive medium to develop a toner image;
backward rotating the driving source; and
driving the second and fourth developers as the driving source is backward rotated and supplying the developing agent to the first photosensitive medium and the second photosensitive medium to develop a toner image.

18. The method of claim 17, wherein the power transmission unit
comprises a plurality of one-way power transmission portions transmitting a rotating force in only one direction, and
wherein the driving of the first and third developers comprises:
transmitting a rotating force transmitted from the driving source to the one-way power transmission portions; and
transmitting a rotating force to only the first and third developers using the one-way power transmission portions to drive the first and third developers.

19. The method of claim 17, wherein the power transmission unit
comprises a plurality of one-way power transmission portions transmitting rotating force in only one direction, and
wherein the backward rotating of the driving source comprises:
transmitting a rotating force transmitted from the driving source to the one-way power transmission portions; and
transmitting a rotating force to only the second and fourth developers using the one-way power transmission portions to drive the second and fourth developers.
